(19) United States
(12) Patent Application Publication
(10) Pub. No.: US 2004/0000987 A1
(43) Pub. Date: Jan. 1, 2004

(54) Check fraud detection process using checks having radio frequency identifier (RFID) tags and a system therefor

(75) Inventors: Kenneth G. De Souza, Kitchener (CA); Sean Woodward, Waterloo (CA); James W.D. Fare, Waterloo (CA); Susan H. Schott, Waterloo (CA)

Correspondence Address: Intellectual Property Section, Law Department, NCR Corporation, 1700 South Patterson Blvd., Dayton, OH, 45479-0001, US

(73) Assignee: NCR Corporation

(21) Appl. No.: 10/184,273

(22) Filed: Jun. 27, 2002

(51) Int. Cl. H04Q 1/00

(52) U.S. Cl. 340/5.8; 705/65

(57) ABSTRACT

A system comprises a first device for receiving from a payor a request to create a check having a radio frequency identifier (RFID) tag associated therewith. A second device is provided for receiving from a payee a request to validate a check having an RFID tag associated therewith. The system further comprises an RFID repository. A processor is provided for (i) receiving check information from the payor, (ii) updating the RFID repository with check information received from the payor, (iii) receiving scanned check information from the payee, (iv) comparing the scanned check information received from the payee with certain information retrieved from the RFID repository, and (v) determining if the check is valid based upon the comparison of the scanned check information received from the payee with the certain information retrieved from the RFID repository. Preferably, the RFID repository comprises a central RFID repository.

### BACKGROUND OF THE INVENTION

The present invention relates to check fraud, and is particularly directed to a check fraud detection process using checks having radio frequency identifier (RFID) tags and a system therefor.

Check fraud is a problem which is costing banks and businesses significant amounts of money. Some common types of check fraud include forging a payor signature on a legitimate blank check, forging an endorsement to someone other than the payee on a stolen check, counterfeiting a check, altering information on a check such as payee or check amount, and check kiting. A typical check has a number of security features for the purpose of preventing it from being easily altered or easily copied. These features include use of colored pantographs, use of moiré patterns, use of chemical reactants that produce stains or cause information to disappear or fade, use of microprinting, use of watermarks, and use of fluorescent inks or fluorescent fibers woven into paper.

Although present checks have features for the purpose of preventing check fraud, a relatively large number of fraudulent checks are still being cashed in during the check cashing process. Costs associated with cashed in fraudulent checks are being absorbed by banks and businesses. It would be desirable to provide a check fraud detection process in which fraudulent checks are detected earlier in the check cashing process to reduce the number of fraudulent checks actually cashed in.

### SUMMARY OF THE INVENTION

In accordance with one aspect of the present invention, a check fraud detection process using checks having radio frequency identifier (RFID) tags associated therewith comprises the steps of receiving from a payor a request to create a check having an RFID tag associated therewith, prompting the payor for check information, receiving check information from the payor, and updating an RFID repository with check information received from the payor. Preferably, the RFID repository comprises a central RFID repository. Also, preferably, the check information includes at least one of the following: name of the payor, address of the payor, name of payee, bank number, account number serial number, tran code, time and date stamp of when the check was created, and creator of the check.

In accordance with another aspect of the present invention, a check fraud detection process using checks having radio frequency identifier (RFID) tags associated therewith comprises the steps of receiving from a payor a request to create a check having an RFID tag associated therewith, retrieving from a memory check information associated with the payor in response to the payor's request to create a check, and updating an RFID repository with the retrieved check information. Preferably, the RFID repository comprises a central RFID repository.

In accordance with another aspect of the present invention, a check fraud detection process using checks having radio frequency identifier (RFID) tags associated therewith comprises the steps of receiving from a payor a request to activate a check having an RFID tag associated therewith, receiving scanned check information from the payor, and updating an RFID repository with the scanned check information received from the payor. Preferably, the RFID repository comprises a central RFID repository.

In accordance with yet another aspect of the present invention, a check fraud detection process using checks having radio frequency identifier (RFID) tags associated therewith comprises the steps of receiving from a payee a request to validate a check having an RFID tag associated therewith, receiving scanned check information from the payee, comparing the scanned check information received from the payee with certain information retrieved from an RFID repository, and determining if the check is valid based upon the comparison of the scanned check information received from the payee with the certain information retrieved from the RFID repository. The method may further comprise the step of updating the RFID repository with the scanned check information received from the payee when the check is determined to be valid. The RFID repository may comprise a central RFID repository.

In accordance with still another aspect of the present invention, a system comprises means for receiving from a payor a request to create a check having a radio frequency identifier (RFID) tag associated therewith, means for prompting the payor for check information, means for receiving check information from the payor, and means for updating an RFID repository with check information received from the payor. Preferably, the RFID repository comprises a central RFID repository. Also, preferably, the check information includes at least one of the following: name of the payor, address of the payor, name of payee, bank number, account number serial number, tran code, time and date stamp of when the check was created, and creator of the check.

In accordance with still another aspect of the present invention, a system comprises means for receiving from a payor a request to create a check having an RFID tag associated therewith, means for retrieving from a memory check information associated with the payor in response to the payor's request to create a check, and means for updating an RFID repository with the retrieved check information. Preferably, the RFID repository comprises a central RFID repository.

In accordance with yet another aspect of the present invention, a system comprises means for receiving from a payor a request to activate a check having a radio frequency identifier (RFID) tag associated therewith, means for receiving scanned check information from the payor, and means for updating an RFID repository with the scanned check information received from the payor. Preferably, the RFID repository comprises a central RFID repository.

In accordance with still another aspect of the present invention, a system comprises means for receiving from a payee a request to validate a check having a radio frequency identifier (RFID) tag associated therewith, means for receiving scanned check information from the payee, means for comparing the scanned check information received from the payee with certain information retrieved from an RFID repository, and means for determining if the check is valid based upon the comparison of the scanned check information received from the payee with the certain information retrieved from the RFID repository. The system may further comprise means for updating the RFID repository with the scanned check information received from the payee when the check is determined to be valid. The RFID repository may comprise a central RFID repository.

In accordance with still another aspect of the present invention, a system comprises a first device for receiving from a payor a request to create a check having a radio frequency identifier (RFID) tag associated therewith, a second device for receiving from a payee a request to validate a check having an RFID tag associated therewith, an RFID repository, and a processor for (i) receiving check information from the payor, (ii) updating the RFID repository with check information received from the payor, (iii) receiving scanned check information from the payee, (iv) comparing the scanned check information received from the payee with certain information retrieved from the RFID repository, and (v) determining if the check is valid based upon the comparison of the scanned check information received from the payee with the certain information retrieved from the RFID repository. Preferably, the RFID repository comprises a central RFID repository.

In accordance with yet another aspect of the present invention, a system comprises

a first device for receiving from a payor a request to activate a check having a radio frequency identifier (RFID) tag associated therewith, a second device for receiving from a payee a request to validate a check having a radio frequency identifier (RFID) tag associated therewith, an RFID repository, and a processor including (i) means for receiving scanned check information from the payor, (ii) means for updating the RFID repository with the scanned check information received from the payor, (iii) means for receiving scanned check information from the payee, (iv) means for comparing the scanned check information received from the payee with certain information retrieved from an RFID repository, and (v) means for determining if the check is valid based upon the comparison of the scanned check information received from the payee with the certain information retrieved from the RFID repository. The RFID repository may comprise a central RFID repository. The processor may include means for updating the RFID repository with the scanned check information received from the payee when the check is determined to be valid.

### BRIEF DESCRIPTION OF THE DRAWINGS

The foregoing and other features of the present invention will become apparent to one skilled in the art to which the present invention relates upon consideration of the following description of the invention with reference to the accompanying drawings, wherein:

FIG. 1 is a diagram of a check having a radio frequency identifier (RFID) tag;

FIG. 2 is a schematic block diagram of a system for processing the check of FIG. 1;

FIG. 3 is a flow diagram of check fraud detection process in accordance with the present invention;

FIG. 4 is another flow diagram of check fraud detection process in accordance with the present invention; and

FIG. 5 is yet another flow diagram of check fraud detection process in accordance with the present invention.

### DETAILS OF THE INVENTION

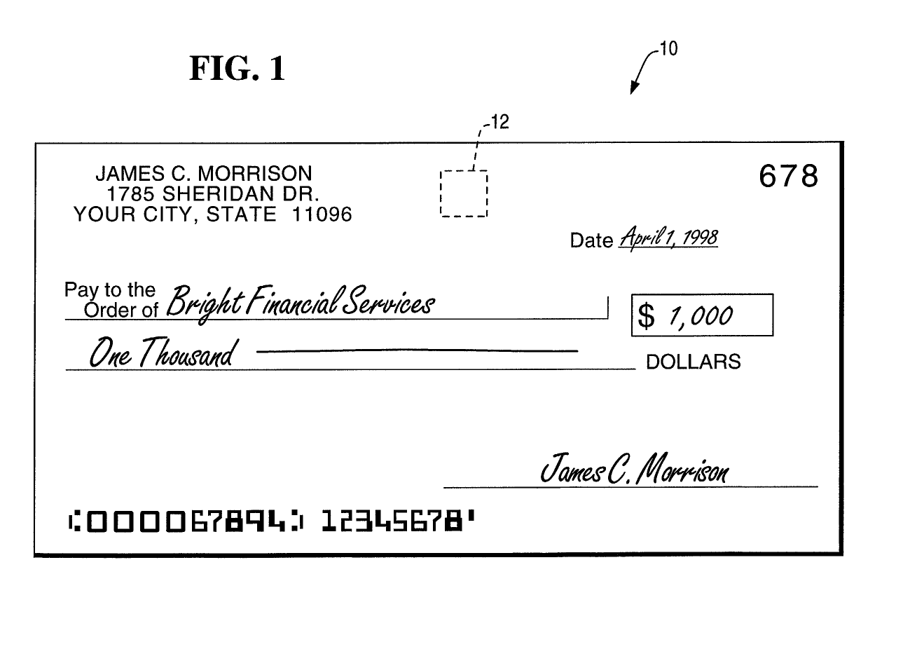

The present invention is directed to check fraud detection processes using checks having radio frequency identifier (RFID) tags and a system therefor. As shown in FIG. 1, a check 10 has an RFID tag 12 associated therewith. The RFID tag 12 may be disposed on a major side surface of the check 10. Preferably, the RFID tag 12 is embedded into the material of the check 10 during manufacture of the check 10.

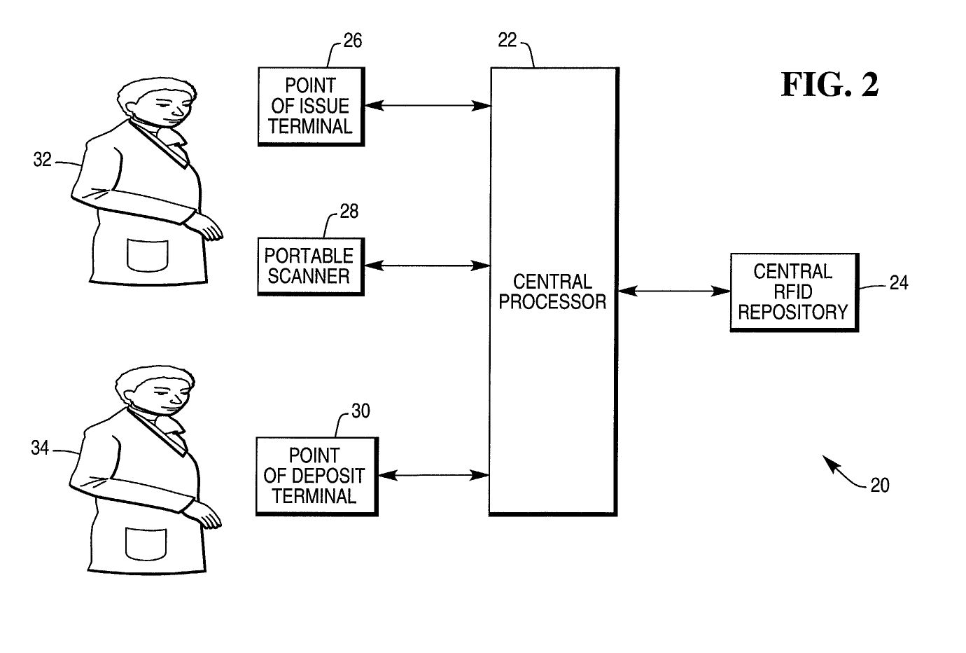

Referring to FIG. 2, a system 20 includes a central processor 22 which is connected in communication with a central RFID repository 24. The central processor is also connected in communication with a point of issue terminal 26, a portable scanner 28, and a point of deposit terminal 30. As shown in FIG. 2, a payor 32 of a check, such as the check 10 shown in FIG. 1, interacts with either the point of issue terminal 26 or the portable scanner to carry out processes in accordance with the present invention, as will be described in detail later. A payee 34 of a check, such as the check 10 shown in FIG. 1, interacts with the point of deposit terminal 30 to carry out a process in accordance with the present invention, as also will be described in detail later.

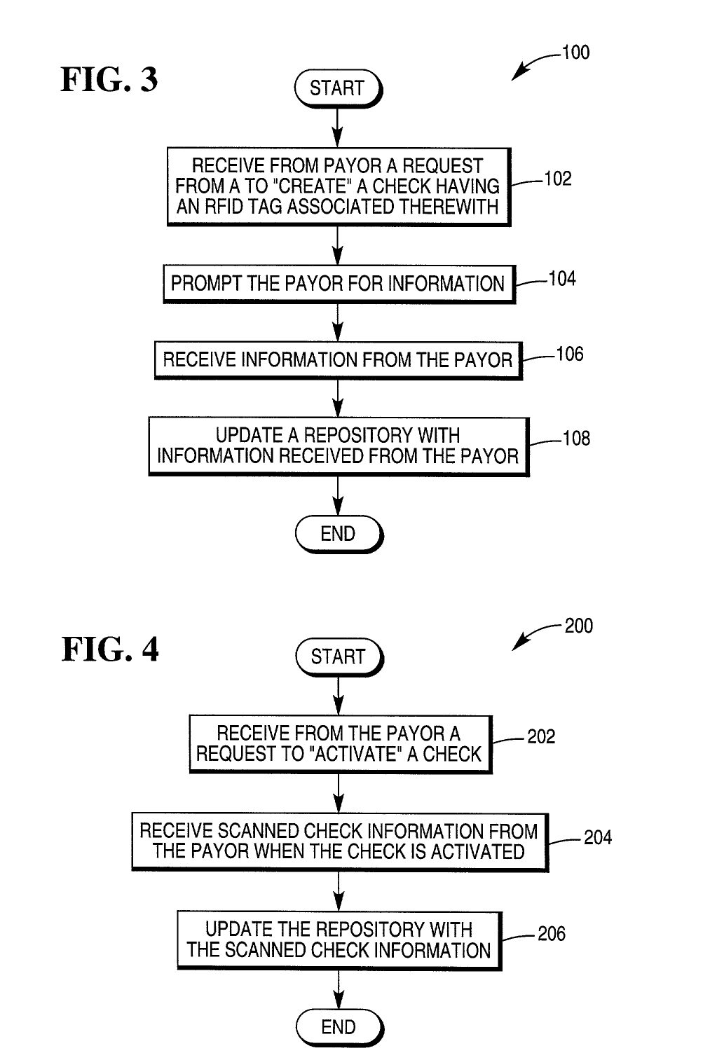

Referring to FIG. 3, a flow diagram 100 depicts operation of a process in accordance with the present invention. In step 102, the processor 22 receives a request from the payor 32 at the point of issue terminal 26 to “create” the check 10. When the check 10 is created, the payor 32 is initially prompted for certain information to enter in at the terminal 26, as shown in step 104. Typical information prompted from the payor 32 includes name of the payor, address of the payor, name of payee, bank number, account number, serial number, tran code, time and date stamp of when the check 10 was created, and the creator of the check 10. This information is received from the payor 32, as shown in step 106. The processor 22 then updates the central RFID repository 24 with this information received from the payor 32, as shown in step 108. The check 10 is created when the central RFID repository 24 is updated with the information received from the payor 32.

Although the above description describes the payor 32 as being prompted for certain information to enter in at the terminal 26, it is contemplated that the certain information may be simply retrieved from a memory if the payor 32 had previously provided such certain information. If this is the case, then the payor 32 need not be prompted to enter in the certain information. It is contemplated that the point of issue terminal 26 may comprise a publicly accessible point-of-sale terminal, for example. As another example, the terminal 26 may comprise a home-based computer.

Referring to FIG. 4, a flow diagram 200 depicts operation of another process in accordance with the present invention. As shown in step 202, the processor 22 receives a request from the payor 32 at the portable scanner 28 to “activate” the check 10 which was created in the process of FIG. 3. When the check 10 is activated, the payor 32 scans the check 10 which now includes a payee name in the payee field of the check 10 and an amount in the amount field of the check 10. The processor 22 receives this scanned check information from the payor 32 as shown in step 204. The processor 22 then updates the central RFID repository 24 with the scanned check information received from the payor 32, as shown in step 206. The check 10 is activated when the central RFID repository 24 is updated with the scanned check information received from the payor 32.

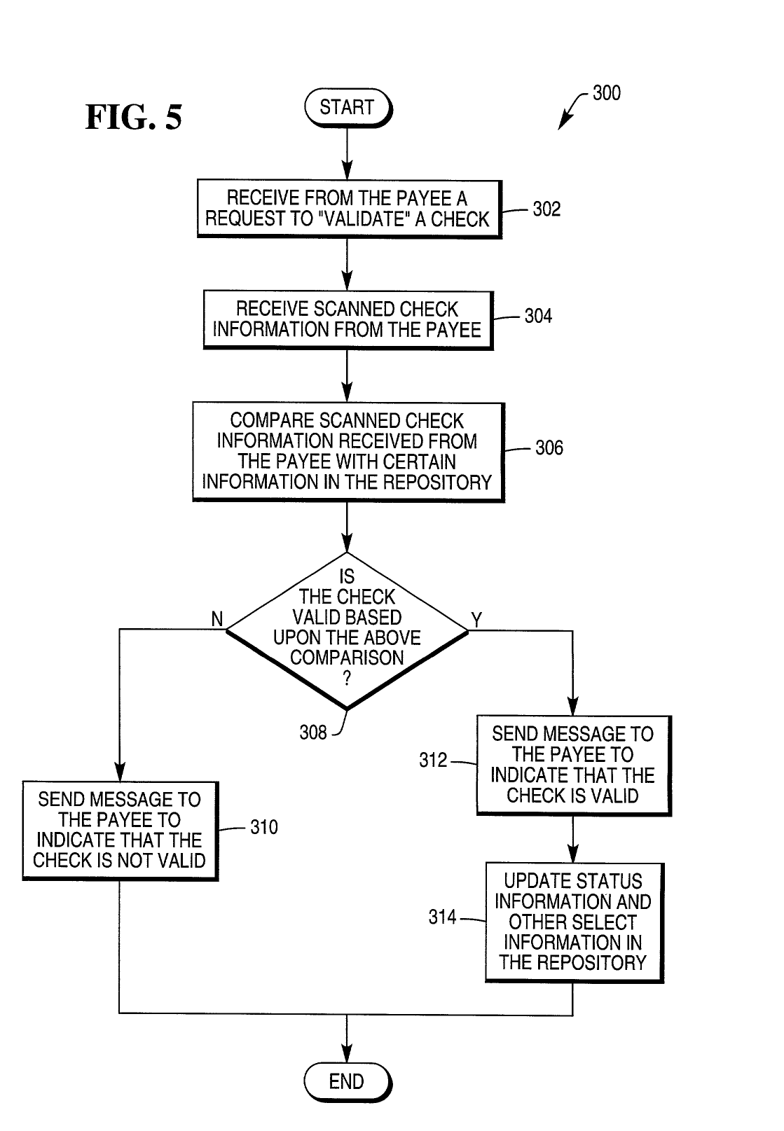

Referring to FIG. 5, a flow diagram 300 depicts operation of yet another process in accordance with the present invention. As shown in step 302, the processor 22 receives a request from the payee 34 to “validate” the check 10 which was activated in the process of FIG. 4 and which check 10 has been physically given from the payor 32 to the payee 34. A validated check indicates a good check in that the check is not a duplicate, for example. Another example of a good check is that the check is not canceled. Still another example of a good check is that the check is not already paid.

When the check 10 is validated, the payee 34 scans the check 10 at the point of deposit terminal 30. The processor 22 receives this scanned check information from the payee 34 as shown in step 304. The processor 22 then compares this scanned check information received from the payee 34 with certain information contained in the central RFID repository 24, as shown in step 306.

A determination is then made in step 308 as to whether or not the check 10 is valid based upon the comparison of information in step 306. If the determination in step 308 is negative, the process proceeds to step 310 in which a message is sent to the payee 34 at the point of deposit terminal 30 to indicate that the check 10 is not valid. However, if the determination in step 308 is affirmative, the process proceeds to step 312 in which a message is sent to the payee 34 at the point of deposit terminal 30 to indicate that the check 10 is valid. The process then proceeds from step 312 to step 314 in which status information and other select information in the central RFID repository 24 is updated. This updates the central RFID repository 24 with the scanned check information received from the payee 34.

Although the above description describes the check 10 having an RFID tag 12 located approximately in the top central portion of the main face of the check as shown in FIG. 1, it is conceivable that the RFID tag 12 be positioned at any location associated with the check 10. It is conceivable that the payor 32 may scan check information at the point of issue terminal 26 instead of using the portable scanner 28. Similarly, it is conceivable that the payee 34 may scan check information using a portable terminal instead of using the point of deposit terminal 30, as shown in FIG. 2.

It is contemplated that the magnetic ink character recognition (MICR) line of the check 10 may also be used to enhance the validation process. For example, check validation may include the steps of reading the MICR line and reading the RFID tag associated with the check 10. Check validation occurs by comparing the check information contained in the MICR fields read from the check and the check information retrieved from the central RFID repository 24. Also, it is contemplated that the repository 24 may be either a central repository (as shown in FIG. 2) or a distributed repository system which has a number of different repositories at different locations. Moreover, it is contemplated that the processor may be either a central processor (as shown in FIG. 2) or a distributed processor system which includes a number of different processors at different locations.

From the above description of the invention, those skilled in the art to which the present invention relates will perceive improvements, changes and modifications. Numerous substitutions and modifications can be undertaken without departing from the true spirit and scope of the invention. Such improvements, changes and modifications within the skill of the art to which the present invention relates are intended to be covered by the appended claims.

What is claimed is:

1. A check fraud detection process using checks having radio frequency identifier (RFID) tags associated therewith, the process comprising the steps of:
receiving from a payor a request to create a check having an RFID tag associated therewith;
prompting the payor for check information;
receiving check information from the payor; and
updating an RFID repository with check information received from the payor.

2. A process according to claim 1, wherein the RFID repository comprises a central RFID repository.

3. A process according to claim 1, wherein the check information includes at least one of the following: name of the payor, address of the payor, name of payee, bank number, account number serial number, tran code, time and date stamp of when the check was created, and creator of the check.

4. A check fraud detection process using checks having radio frequency identifier (RFID) tags associated therewith, the process comprising the steps of:
receiving from a payor a request to create a check having an RFID tag associated therewith;
retrieving from a memory check information associated with the payor in response to the payor's request to create a check; and
updating an RFID repository with the retrieved check information.

5. A process according to claim 4, wherein the RFID repository comprises a central RFID repository.

6. A check fraud detection process using checks having radio frequency identifier (RFID) tags associated therewith, the process comprising the steps of:
receiving from a payor a request to activate a check having an RFID tag associated therewith;
receiving scanned check information from the payor; and
updating an RFID repository with the scanned check information received from the payor.

7. A process according to claim 6, wherein the RFID repository comprises a central RFID repository.

8. A check fraud detection process using checks having radio frequency identifier (RFID) tags associated therewith, the process comprising the steps of:
receiving from a payee a request to validate a check having an RFID tag associated therewith;
receiving scanned check information from the payee;
comparing the scanned check information received from the payee with certain information retrieved from an RFID repository; and
determining if the check is valid based upon the comparison of the scanned check information received from the payee with the certain information retrieved from the RFID repository.

9. A process according to claim 8, further comprising the step of:
updating the RFID repository with the scanned check information received from the payee when the check is determined to be valid.

10. A process according to claim 8, wherein the RFID repository comprises a central RFID repository.

11. A system comprising:
means for receiving from a payor a request to create a check having a radio frequency identifier (RFID) tag associated therewith;
means for prompting the payor for check information;
means for receiving check information from the payor; and
means for updating an RFID repository with check information received from the payor.

12. A system according to claim 11, wherein the RFID repository comprises a central RFID repository.

13. A system according to claim 11, wherein the check information includes at least one of the following: name of the payor, address of the payor, name of payee, bank number, account number serial number, tran code, time and date stamp of when the check was created, and creator of the check.

14. A system comprising:
means for receiving from a payor a request to create a check having an RFID tag associated therewith;
means for retrieving from a memory check information associated with the payor in response to the payor's request to create a check; and
means for updating an RFID repository with the retrieved check information.

15. A process according to claim 14, wherein the RFID repository comprises a central RFID repository.

16. A system comprising:
means for receiving from a payor a request to activate a check having a radio frequency identifier (RFID) tag associated therewith;
means for receiving scanned check information from the payor; and
means for updating an RFID repository with the scanned check information received from the payor.

17. A system according to claim 16, wherein the RFID repository comprises a central RFID repository.

18. A system comprising:
means for receiving from a payee a request to validate a check having a radio frequency identifier (RFID) tag associated therewith;
means for receiving scanned check information from the payee;
means for comparing the scanned check information received from the payee with certain information retrieved from an RFID repository; and
means for determining if the check is valid based upon the comparison of the scanned check information received from the payee with the certain information retrieved from the RFID repository.

19. A system according to claim 18, further comprising means for updating the RFID repository with the scanned check information received from the payee when the check is determined to be valid.

20. A system according to claim 18, wherein the RFID repository comprises a central RFID repository.

21. A system comprising:
a first device for receiving from a payor a request to create a check having a radio frequency identifier (RFID) tag associated therewith;
a second device for receiving from a payee a request to validate a check having an RFID tag associated therewith;
an RFID repository; and
a processor for (i) receiving check information from the payor, (ii) updating the RFID repository with check information received from the payor, (iii) receiving scanned check information from the payee, (iv) comparing the scanned check information received from the payee with certain information retrieved from the RFID repository, and (v) determining if the check is valid based upon the comparison of the scanned check information received from the payee with the certain information retrieved from the RFID repository.

22. A system according to claim 21, wherein the RFID repository comprises a central RFID repository.

23. A system comprising:
a first device for receiving from a payor a request to activate a check having a radio frequency identifier (RFID) tag associated therewith;
a second device for receiving from a payee a request to validate a check having a radio frequency identifier (RFID) tag associated therewith;
an RFID repository; and
a processor including (i) means for receiving scanned check information from the payor, (ii) means for updating the RFID repository with the scanned check information received from the payor, (iii) means for receiving scanned check information from the payee, (iv) means for comparing the scanned check information received from the payee with certain information retrieved from an RFID repository, and (v) means for determining if the check is valid based upon the comparison of the scanned check information received from the payee with the certain information retrieved from the RFID repository.

24. A system according to claim 23, wherein the RFID repository comprises a central RFID repository.

25. A system according to claim 23, wherein the processor includes means for updating the RFID repository with the scanned check information received from the payee when the check is determined to be valid.
